(19) United States
(12) Patent Application Publication
(10) Pub. No.: US 2019/0087644 A1
(43) Pub. Date: Mar. 21, 2019

(54) ADAPTIVE SYSTEM AND METHOD FOR OBJECT DETECTION

(71) Applicants: NCKU Research and Development Foundation, Tainan City (TW); Himax Technologies Limited, Tainan City (TW)

(72) Inventors: Ming-Der Shieh, Tainan City (TW); Chun-Wei Chen, Tainan City (TW); Hsiang-Chih Hsiao, Tainan City (TW); Der-Wei Yang, Tainan City (TW)

(21) Appl. No.: 15/705,790

(22) Filed: Sep. 15, 2017

(51) Int. Cl. G06K 9/00

(52) U.S. Cl. CPC G06K 9/00288; G06K 9/00268; G06K 9/00228

(57) ABSTRACT

The present invention is directed to an adaptive method for object detection. A predetermined number of next window images following a current window image are skipped, if a current likelihood value is less than a predetermined background threshold. The object detection early terminates, if a previous window image preceding the current window image contains the object to be detected and the current likelihood value is greater than or equal to a predetermined foreground threshold.

### BACKGROUND OF THE INVENTION

### 1. Field of the Invention

The present invention generally relates to object detection, and more particularly to an adaptive system and method for object detection.

### 2. Description of Related Art

Object detection, for example, face detection, is a computer technology being used in a variety of applications that identifies locations and sizes of all objects in a digital image. Paul Viola and Michael Jones proposed in 2001 an object detection framework that provides competitive object detection rates in real-time. The Viola-Jones method is robust with high detection rate, and is adaptable for real-time applications in which, for example, at least two frames per second should be processed. The Viola-Jones method adopts cascade training mechanism to achieve better detection rates.

There is a growing trend towards low-power applications (e.g., smart phones) that have limited electric and processing power and/or fast applications that require fast (though usually rough) object detection. Therefore, accurate or real-time object detection may be difficult or impossible to achieve in such applications using existing methods. Therefore, a need has thus arisen to propose a novel method to effectively accelerate object detection.

### SUMMARY OF THE INVENTION

In view of the foregoing, it is an object of the embodiment of the present invention to provide an adaptive system and method for object detection that is capable of quickly detecting objects by skipping window images or early terminating adaptively according to background and/or foreground locality.

According to one embodiment, object detection is performed on a current window image, thereby generating a current likelihood value indicating how likely an object is detected. A predetermined number of next window images following the current window image are skipped, if the current likelihood value is less than a predetermined background threshold.

According to another embodiment, object detection is performed on a current window image, thereby generating a current likelihood value indicating how likely an object is detected. The object detection early terminates, if a previous window image preceding the current window image contains the object to be detected and the current likelihood value is greater than or equal to a predetermined foreground threshold.

### BRIEF DESCRIPTION OF THE DRAWINGS

FIG. 1 shows a block diagram illustrated of an adaptive system for object detection according to one embodiment of the present invention;

FIG. 2 shows a block diagram illustrated of a stage classifier of FIG. 1;

FIG. 3 shows a flow diagram illustrated of an adaptive method for object detection according to one embodiment of the present invention; and

FIG. 4 shows an exemplary curve illustrating distribution of likelihood values with respect to window images in a sequence of a row.

### DETAILED DESCRIPTION OF THE INVENTION

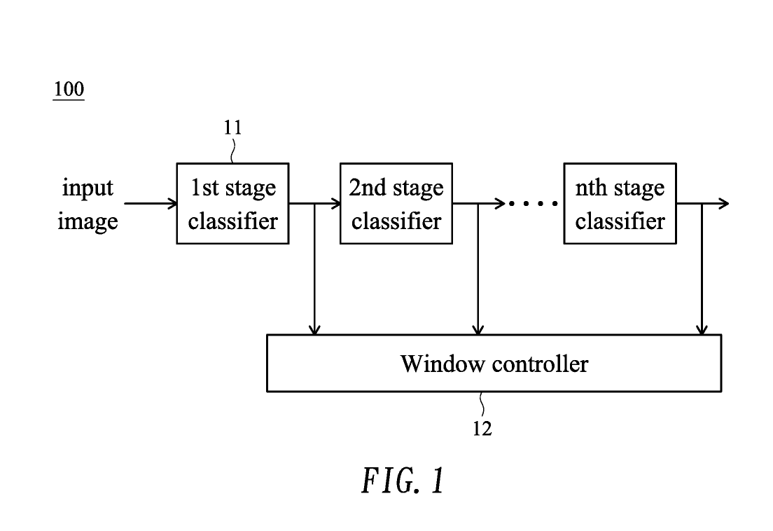

FIG. 1 shows a block diagram illustrated of an adaptive system 100 for object detection according to one embodiment of the present invention. The adaptive system 100 of the embodiment may be adaptable for, but not limited to, face detection. In one exemplary embodiment, the adaptive system 100 is a face detector of Viola and Jones, details of which may be referred to “Rapid Object Detection Using a Boosted Cascade of Simple Features,” entitled to Paul Viola et al., Conference on Computer Vision and Pattern Recognition 2001; and “Robust Real-time Object Detection,” entitled to Paul Viola et al., July 2001, Second International Workshop on Statistical and Computational Theories of Vision—Modeling, Learning, Computing, and Sampling,” the disclosures of which are incorporated herein by reference.

In the embodiment, the adaptive system 100 may include a plurality of classifiers 11 (e.g., first stage classifier to nth stage classifier as exemplified in FIG. 1) that are operatively connected in series, resulting in a multistage system or cascading classifiers 11. The adaptive system 100 of the embodiment may include a window controller 12 that is configured to determine a next scanning window for the cascading classifiers 11 based on the outputs of the cascading classifiers 11 applied to a current scanning window. To search for the object in the entire frame of an input image, the scanning window moves across the input image (e.g., scans horizontally left-to-right and moves downward, or raster scanning) and an image within the scanning window (or window image for short) is subjected to detection by the cascading classifiers 11. According to one aspect of the embodiment, the window controller 12 is capable of quickly detecting objects, which will be described in details in the following paragraphs.

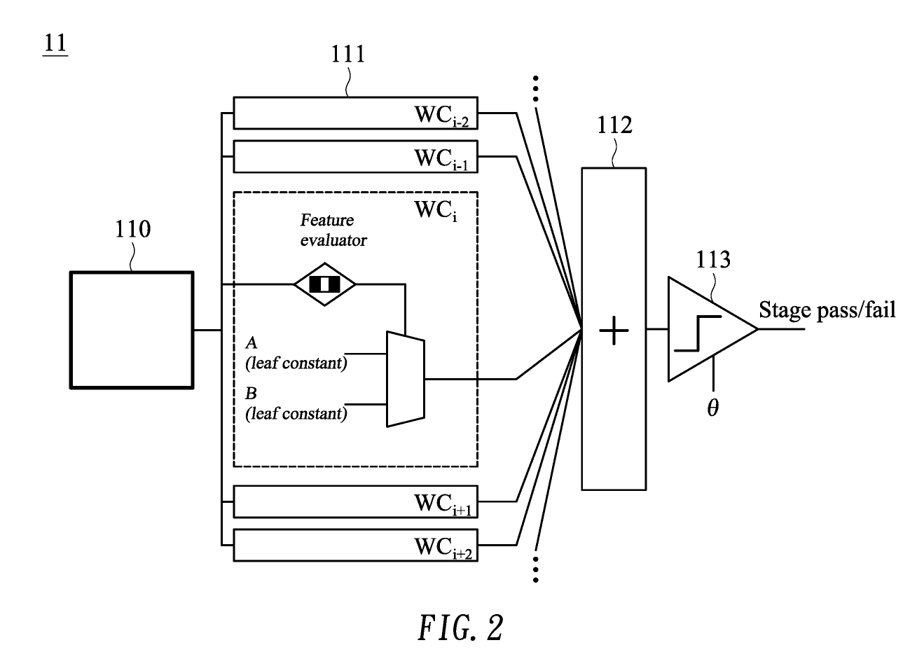

FIG. 2 shows a block diagram illustrated of a stage classifier 11 of FIG. 1. In the embodiment, the classifier 11 may include a plurality of sub-classifiers such as weak classifiers 111 (e.g., WC-ᵢ₋₂ to WCᵢ₊2), each is composed of one feature (e.g., Haar feature). A detailed block diagram of a weak classifier, e.g., WCᵢ, is also exemplified. In general, a feature is a piece of information which is relevant for solving the computational task related to a certain application. Features may be specific structures in the image such as points, edges or objects. Every object class has its own special features that help in classifying the class. For example, in face detection, eyes, nose and lips can be accordingly found and features like skin color and distance between eyes can be found.

As shown in FIG. 2, an image within a (current) scanning window 110 is subjected to detection by the weak classifiers 111. It is appreciated that a ‘weak’ classifier (or learner) is well known and commonly used in machine learning or object detection field to denote a classifier that is computationally simple and performs barely or in simple manner. Many instances of the weak classifiers are ordinarily grouped together to produce a ‘strong’ classifier.

The classifier 11 of the embodiment may include a summing device 112 that is configured to collect and sum up scores generated by the weak classifiers 112, therefore generating a score sum. In the specification, the score of the weak classifier 112 may be a numerical value indicating a level of confidence that a stage will produce a stage decision of face or non-face (e.g., corresponding to a measure how likely it is that a face is present or not present within a scanning window). The score sum is then compared with a predetermined stage threshold by a comparator 113. The classifier 11 can decide, based on the comparison result of the comparator 113, whether the scanning window 110 contains at least a portion of the object (e.g., the face). If the classifier 11 decides in the affirmative, the stage thereof passes, otherwise that stage fails. If one stage passes, the image of the same scanning window 110 is then subjected to detection in the next stage with more features and more time consumed. According to pass/fail conditions of the cascading classifiers 11, the adaptive system 100 (FIG. 1) may generate a likelihood value indicating how likely an object is detected by the cascading classifiers 11. In the embodiment, for example, the likely value is m if the first m stages pass.

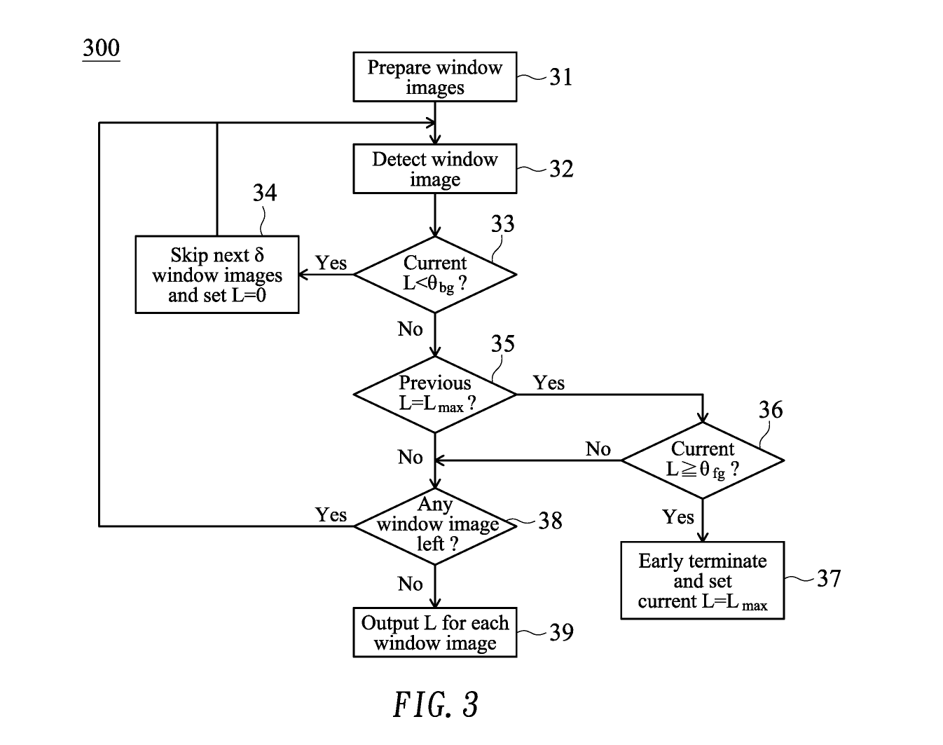

FIG. 3 shows a flow diagram illustrated of an adaptive method 300 for object (e.g., face) detection according to one embodiment of the present invention. In step 31, a plurality of window images in a row of an input image are prepared. For example, consecutive window images in a row that are spaced one pixel apart from each other are prepared. In step 32, a current window image is then subjected to detection by the cascading classifiers 11.

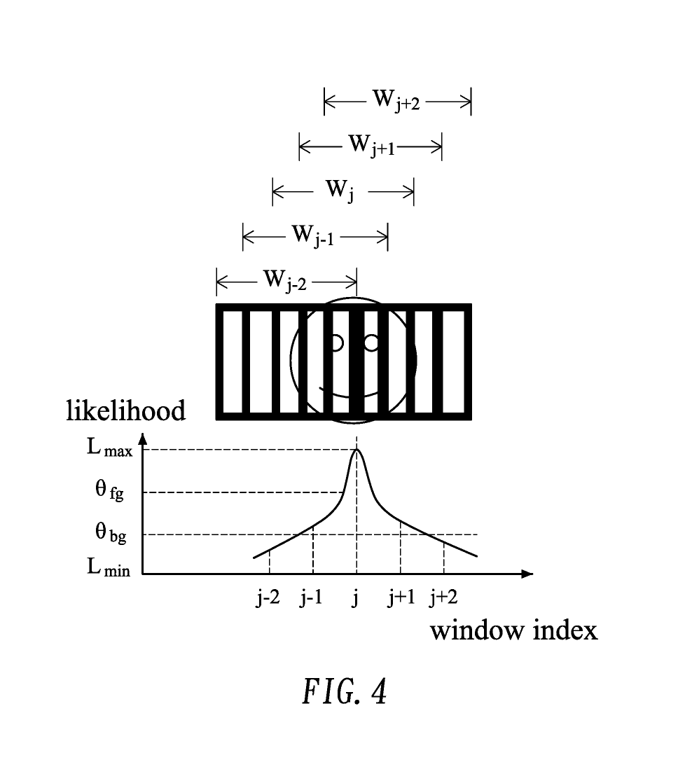

FIG. 4 shows an exemplary curve illustrating distribution of likelihood values with respect to window images in a sequence of a row. In general, the likelihood value of a window image containing the object (e.g., a face) to be detected is substantially large, which, for example, may be greater than a predetermined foreground threshold θ_{fg}, while the likelihood value of a window image not containing the object to be detected is substantially small, which, for example, may be less than a predetermined background threshold θ_{bg}, where θ_{bg}<θ_{fg}. As exemplified in FIG. 4, the window image Wⱼ contains the object (e.g., a face) and thus has a likelihood value greater than the predetermined foreground threshold θ_{fg}, and the window image Wⱼ₊₂ contains no object and thus has a likelihood value less than the predetermined background threshold θ_{bg}.

In step 33, a current likelihood value L is compared with the predetermined background threshold θ_{bg}. If the current likelihood value L is less than the predetermined background threshold θ_{bg}. (i.e., L<θ_{bg}), it indicates that the current window image and neighboring window images are background images not containing the object to be detected. That is, the current window image is in a background locality. Therefore, a predetermined number δ of next window images following the current window image are skipped in step 34, where δ is a preset value representing a degree of locality. In other words, the skipped window images are not subjected to detection, thereby accelerating the object detection. Moreover, in step 34 of the embodiment, likelihood values of the skipped window images are set with a minimum likelihood value Lₘᵢₙ (e.g., L=0), which represents absence of the object to be detected. In an alternative embodiment, likelihood values of the skipped window images are set with a predetermined value less than the predetermined background threshold θ_{bg}.

If the result of step 33 is negative (i.e., L≥θ_{bg}), indicating that the current window image and neighboring window images are not background images, a previous likelihood value L (associated with a previous window image) is compared with a maximum likelihood value Lₘₐₓ (e.g., 25) in step 35, which represents presence of the object to be detected. In an alternative embodiment, step 35 determines whether a previous likelihood value L (of a previous window image) is greater than a predetermined value that is greater than the predetermined foreground threshold θ_{fg}.

If the previous likelihood value L is equal to the maximum likelihood value Lₘₐₓ in step 35, indicating that the previous window image preceding the current window image contains the object to be detected, the current likelihood value L is further compared with the predetermined foreground threshold θ_{fg} in step 36. If the current likelihood value L is greater than or equal to the predetermined foreground threshold θ_{fg}. (i.e., L≥θ_{fg}), it indicates that the current window image is a foreground image containing the object to be detected. That is, the current window image is in a foreground locality. Therefore, remaining window images that have not yet been subjected to detection are skipped in step 37. In other words, the skipped window images are not subjected to detection or the flow of the adaptive method 300 early terminates, thereby accelerating the object detection. Moreover, in step 37 of the embodiment, likelihood values of the skipped window images are set with a maximum likelihood value Lₘₐₓ, which represents presence of the object to be detected. In an alternative embodiment, likelihood values of the skipped window images are set with a predetermined value that is greater than the predetermined foreground threshold θ_{fg}.

If either result of step 35 or step 36 is negative, the flow of the adaptive method 300 geos to step 38 to determine whether any window image remains undetected. If the determination is affirmative, the flow of the adaptive method 300 goes to step 32 for detecting a subsequent window image, otherwise the flow goes to step 39, in which the likelihood values L for the window images in the row are outputted.

According to the embodiment proposed above, a plurality of window images may be skipped when the current window image is in a background locality, or the adaptive method 300 may terminate early when the current window image is in a foreground locality, thereby saving substantial processing time and associated power. Accordingly, the embodiment of the present invention may, for example, be adapted to a normally-operated low-power (or power-limited) camera that is capable of quickly detecting objects.

Although specific embodiments have been illustrated and described, it will be appreciated by those skilled in the art that various modifications may be made without departing from the scope of the present invention, which is intended to be limited solely by the appended claims.

1. An adaptive method for object detection adapted to a power-limited camera, comprising:
performing object detection on a current window image, thereby generating a current likelihood value indicating how likely an object is detected; and
skipping a predetermined number of next window images following the current window image, if the current likelihood value is less than a predetermined background threshold.

2. The method of claim 1, further comprising a step of setting the skipped window images with a minimum likelihood value, which represents absence of the object to be detected.

3. The method of claim 1, further comprising a step of preparing a plurality of window images in a row of an input image.

4. The method of claim 1, wherein the objection detection is performed by cascading classifiers.

5. An adaptive method for object detection adapted to a power-limited camera, comprising:
performing object detection on a current window image, thereby generating a current likelihood value indicating how likely an object is detected; and
early terminating the object detection, if a previous window image preceding the current window image contains the object to be detected and the current likelihood value is greater than or equal to a predetermined foreground threshold.

6. The method of claim 5, wherein the previous window image contains the object to be detected when a previous likelihood value associated with the previous window image is equal to a maximum likelihood value, which represents presence of the object to be detected.

7. The method of claim 5, further comprising a step of setting the current window image with a maximum likelihood value, which represents presence of the object to be detected.

8. The method of claim 5, further comprising a step of preparing a plurality of window images in a row of an input image.

9. The method of claim 5, wherein the objection detection is performed by cascading classifiers.

10. An adaptive method for object detection adapted to a power-limited camera, comprising:
preparing a plurality of window images in a row of an input image;
performing object detection on a current window image, thereby generating a current likelihood value indicating how likely an object is detected;
skipping a predetermined number of next window images following the current window image, if the current likelihood value is less than a predetermined background threshold; and
when the current likelihood value is not less than the predetermined background threshold, early terminating the object detection, if a previous window image preceding the current window image contains the object to be detected and the current likelihood value is greater than or equal to a predetermined foreground threshold.

11. The method of claim 10, further comprising a step of setting the skipped window images with a minimum likelihood value, which represents absence of the object to be detected.

12. The method of claim 10, wherein the previous window image contains the object to be detected when a previous likelihood value associated with the previous window image is equal to a maximum likelihood value, which represents presence of the object to be detected.

13. The method of claim 10, further comprising a step of setting the current window image with a maximum likelihood value, which represents presence of the object to be detected, after early terminating the object detection.

14. The method of claim 10, wherein the objection detection is performed by cascading classifiers.

15. An adaptive system for object detection adapted to a power-limited camera, comprising:
a plurality of classifiers operatively connected in series to result in cascading classifiers;
a window controller that determines a next scanning window for the cascading classifiers based on outputs of the cascading classifiers applied to a current scanning window;
wherein the cascading classifiers performs object detection on the current window image, thereby generating a current likelihood value indicating how likely an object is detected;
the window controller skips a predetermined number of next window images following the current window image, if the current likelihood value is less than a predetermined background threshold; and
the window controller early terminates the object detection, if a previous window image preceding the current window image contains the object to be detected and the current likelihood value is greater than or equal to a predetermined foreground threshold.

16. The system of claim 15, wherein the window controller further sets the skipped window images with a minimum likelihood value, which represents absence of the object to be detected.

17. The system of claim 15, wherein the previous window image contains the object to be detected when a previous likelihood value associated with the previous window image is equal to a maximum likelihood value, which represents presence of the object to be detected.

18. The system of claim 15, wherein the window controller further sets the current window image with a maximum likelihood value, which represents presence of the object to be detected, after early terminating the object detection.

19. The system of claim 15, wherein each said classifier comprises a plurality of sub-classifiers, each is composed of one feature.

20. The system of claim 19, wherein the classifier further comprises:
a summing device that collects and sums up scores generated by the sub-classifiers, therefore generating a score sum; and
a comparator that compares the score sum with a predetermined stage threshold, thereby generating comparison result, based on which to decide whether the current window image contains at least a portion of the object to be detected.
